(19) United States
(12) Patent Application Publication
(10) Pub. No.: US 2020/0387166 A1
(43) Pub. Date: Dec. 10, 2020

(54) Autonomous Loading and Unloading of Cargo Container

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(21) Appl. No.: 16/430,524

(22) Filed: Jun. 4, 2019

(51) Int. Cl. G05D 1/02; B65G 67/20; G05D 1/00

(52) U.S. Cl. CPC G05D 1/0289; B65G 67/20; G05D 2201/0213; G05D 1/0088; G05D 1/0214

(57) ABSTRACT

The present invention describes a system comprising an autonomous vehicle equipped with a mechanism with lifting and depositing a container, a sensing mechanism on the autonomous vehicle that allows it to sense the pose of the container, a sensing mechanism in the autonomous vehicle that allows it to measure the support surface of the ground surrounding the container to be lifted or the area where the container is deposited and a planning algorithm that creates a trajectory that moves the autonomous vehicle from the current pose to a pose where the lifting/depositing mechanism can operate on the container to be lifted/dropped. An algorithm has been developed to automatically position the PLS to align with the trailer in autonomous vehicles for the loading maneuver. A set of “mud proof” fiducials has been developed that allow accurate alignment between the PLS and the trailer. This mechanism is leveraged for this behavior. The level of alignment necessary for this behavior is similar in accuracy given the larger size of the platforms. Unloading is a simpler maneuver and also the system has to automatically find a flat spot suitable for the unloading maneuver. There has been automatic determination of the pose of the container on the ground and determination if the area needed for the loading has enough space for maneuver. Also, there is automatic planning and execution of the plan to position for the loading system and execution of the loading maneuver. In the case of the unloading maneuver, it comprises having the operator provide the desired pose of the container when left in the ground.

### CROSS-REFERENCES TO RELATED APPLICATIONS

Not applicable.

### BACKGROUND OF THE INVENTION

### 1. Field of the Invention

The present invention comprises a system with an autonomous vehicle equipped with a mechanism for lifting and depositing a container, a sensing mechanism on the autonomous vehicle that allows it to sense the pose of the container, a sensing mechanism in the autonomous vehicle that allows it to measure the support surface of the ground surrounding the container to be lifted or the area where the container is deposited and a planning algorithm that creates a trajectory that moves the autonomous vehicle from the current pose to a pose where the lifting/depositing mechanism can operate on the container to be lifted/dropped. The algorithm that has been developed automatically positions the PLS to align with the trailer in autonomous vehicles for the loading maneuver. “Mud proof” fiducials have been developed that allow accurate alignment between the PLS and the trailer of the autonomous vehicle. The level of alignment required for the loading maneuver is similar in accuracy given the larger size of the platforms. In the case of the unloading maneuver, this is a much simpler maneuver. The system has to automatically find a flat spot that is suitable for the unloading maneuver. Also, there is automatic determination of the pose of the container on the ground and determination if the area execution of the plan to position for the loading system and execution of the loading maneuver. Also, for the unloading maneuver, the operator provides the desired pose of the container when left in the ground.

### 2. Description of Related Art

The statements in this section merely provide background information related to the present disclosure and may not constitute prior art.

There have been no reports in the patent literature on the development of a system that comprises an autonomous vehicle equipped with a mechanism for lifting and depositing a container, a sensing mechanism allowing the autonomous vehicle to sense the pose of the container to be lifted/deposited, a sensing mechanism allowing it to measure the support surface of the ground surrounding the container to be lifted or the area where the container will be deposited, and a planning algorithm that creates a trajectory that moves the autonomous vehicle from the current pose to a pose where the lifting/depositing mechanism can operate on the container to be lifted/deposited.

There has been a patent on an autonomous mobile robotic system developed for bounded areas that includes a navigation beacon and an autonomous coverage robot as can be seen in U.S. Pat. No. 8,380,350. The navigation beacon has a gateway beacon emitter that is arranged to transmit a gateway marking emission with the navigation beacon disposed within a gateway between the first bounded area and an adjacent second bounded area. The autonomous coverage robot has a beacon emission sensor responsive to the beacon emission, and a drive system configured to maneuver the robot around the first bounded area in a cleaning mode where the robot is redirected in response to detecting the gateway marking emission. The drive system is also configured to maneuver the robot through the gateway into the second bounded area in a migration mode. While this patent discusses movement between two bounded areas, there is no discussion of loading and unloading maneuvers and alignment of the PLS with the trailer of the autonomous vehicle. There is no discussion of a mechanism of lifting and depositing a container by autonomous vehicles.

There has been a navigation system developed using self-describing fiducials in GPS-denied environments which includes a communication element that communicates the navigation-aiding information to one or more navigating objects in the vicinity of the self-describing fiducial. This system is described in U.S. patent application Ser. No. 15/588,661. It is worth noting that these are not “mud proof” fiducials that are used for the automatic alignment of the PLS with the trailer as shown in the present invention. There is also no discussion of a mechanism for lifting and depositing containers by autonomous vehicles.

There have been no reports in the literature on the development of a system such as described in the present invention where there is an autonomous vehicle with a mechanism for lifting and depositing a container, a sensing mechanism on the autonomous vehicle that allows it to sense the pose of the container to be lifted/deposited, a sensing mechanism on the autonomous vehicle that allows for the measurement of the support surface of the ground surrounding the container to be lifted or the area where the container will be deposited and a planning algorithm that creates a trajectory that moves the autonomous vehicle from the current pose to a pose where the lifting/depositing mechanism can operate on the container to be lifted/dropped.

### SUMMARY OF THE INVENTION

The present invention relates to a system that comprises an autonomous vehicle equipped with a mechanism for lifting and depositing an ISO container, a sensing mechanism on the autonomous vehicle that allows the truck to sense the pose of the ISO container to be lifted or dropped, a sensing mechanism on the autonomous vehicle that allows it to measure the support surface of the ground surrounding the ISO container to be lifted or the area where the container will be deposited and a planning algorithm that creates a trajectory that moves the autonomous vehicle from the current pose to a pose where the lifting/depositing mechanism can operate on the ISO container to be lifted/dropped.

An algorithm has been developed in which the PLS has been automatically aligned with the trailer in autonomous vehicles for the loading and unloading maneuvers. A set of “mud proof” fiducials has been developed which allow for accurate alignment between the PLS and the trailer for both the loading and unloading maneuvers.

The level of alignment necessary for this behavior is similar in accuracy given the larger size of the platforms.

While unloading is a simpler maneuver than loading, the system has to automatically find a flat spot that is suitable for the unloading maneuver to occur. There is automatic determination of the pose of the container on the ground and determination if the area needed for the loading has enough space for maneuver.

There is also automatic planning and execution of the plan to position for the loading system and execution of the loading maneuver. In the case of unloading, the operator provides the desired pose of the container when left in the ground.

### BRIEF DESRIPTION OF THE DRAWINGS

The present invention is described in the detailed description that follows, with reference to the following noted drawings that illustrate non-limiting examples of embodiments of the present invention, and in which like reference numerals represent similar parts throughout the drawings.

FIG. 1—Illustration of the autonomous vehicle in the initial state (100) and maneuvering for aligning with container and then the autonomous vehicle in the loading state (103) where there is a loading mechanism (102) to load the cargo container (101). The entire process is conducted in an area suitable for driving (104).

FIG. 2—Illustration of the autonomous vehicle with the container (200) and then when it is ready to unload (201) with the desired position for unloading (202) indicated. The whole process is done in the area suitable for driving (203) and the outside area is unsuitable for driving.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth herein, the terms “a,” “an,” and “the” are not limited to one element, but instead should be read as meaning “at least one.” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

In the present invention, there has been a system that has been developed that comprises an autonomous vehicle equipped with a mechanism for lifting and depositing a container, a sensing mechanism on the autonomous vehicle for it to sense the pose of the container, a sensing mechanism on the autonomous vehicle for measurement of the support surface of the ground surrounding the container to be lifted or the area where the container is deposited, and a planning algorithm that creates a trajectory that moves the autonomous vehicle from the current pose to a pose where the lifting/depositing mechanism can operate on the container to be lifted/dropped.

This system involves an autonomous vehicle that contains a mechanism for lifting and depositing an ISO container. It also has a sensing mechanism on the autonomous vehicle that detects the pose of the ISO container as well as a sensing mechanism for measurement of the support surface of the ground surrounding the ISO container to be lifted or the area where the ISO container is deposited. There is also a planning algorithm creating a trajectory which moves the autonomous vehicle from the original pose to a pose where the lifting/depositing mechanism can be done on the ISO container.

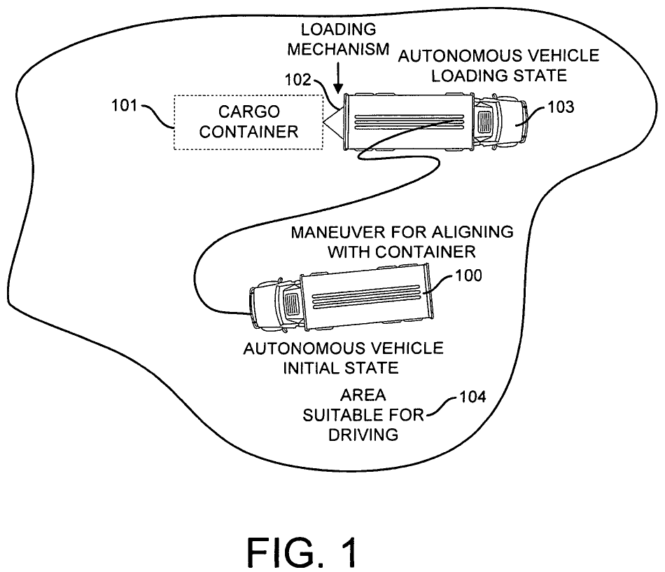

The autonomous vehicle starts from its initial position and maneuvers for aligning with the container. Then the autonomous vehicle is in the loading state and a loading mechanism is applied to the cargo container. The loading process is illustrated in FIG. 1. The autonomous vehicle starts out in the initial state (100) and maneuvers for aligning with the container. The cargo container to be loaded is illustrated in (101) and the loading mechanism (102) is used to load the cargo to the autonomous vehicle. The entire loading process (103) occurs in an area that is suitable for driving (104).

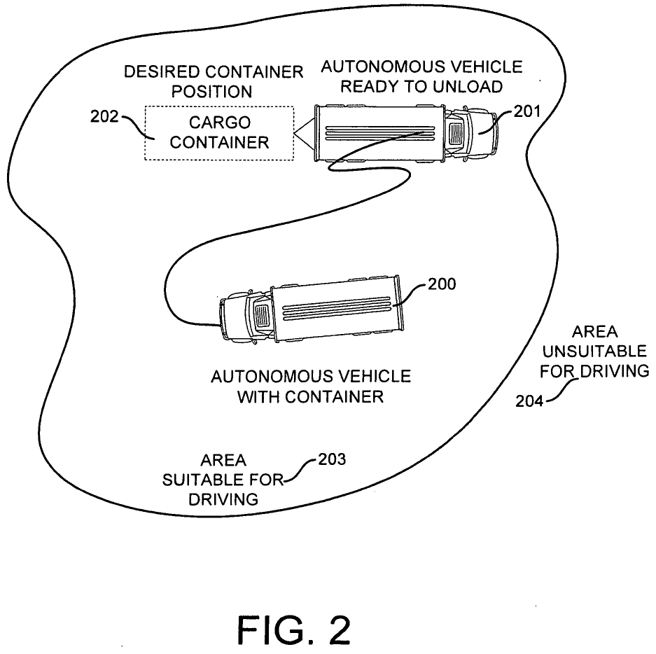

The unloading process is illustrated in FIG. 2. In the case of unloading, the autonomous vehicle starts with the container (200) and then it is ready to unload (201) to the desired container position (202). Again, this process is conducted in an area that is suitable for driving and the area outside this region is unsuitable for driving (204).

A pose is a sustained posture that the container maintains and changes when the lifting or depositing occurs. ISO containers are intermodal containers that are used for intermodal transport of freight. They are manufactured according to specifications from the International Organization for Standardization (ISO) and are suitable for multiple transportation methods such as truck, rail, or ship.

In this system, the sensors for detecting the relative pose of the container and autonomous vehicle are placed on both the ISO container to be lifted/deposited and on the autonomous vehicle. In addition, the sensors for detecting the pose for the trailer and the ISO container to be lifted/deposited are located in the area surrounding where the maneuver is taking place.

The autonomous vehicle has a drive by wire kit that executes the motion (trajectory that moves the autonomous vehicle from the current pose to a pose where the lifting/depositing mechanism can operate on the container to be lifted/dropped) that is described by the planning algorithm. A drive-by-wire system is the use of electrical or electro-mechanical systems for performing vehicle functions traditionally achieved by mechanical linkages. In addition, the autonomous vehicle has a user interface that guides the truck driver to perform the maneuver specified by the planner. This maneuver is the trajectory that moves the autonomous vehicle from the current pose to the pose where the lifting/depositing mechanism can operate on the container to be lifted/dropped.

The yard coordinator specifies a set of poses for the containers to be lifted or deposited. The poses that are specified by the yard coordinator for the containers are used as the starting or ending poses of the trajectories by the planning algorithm of the system that has been developed.

The system has a planning algorithm that is constrained to only allow the autonomous vehicle to drive in areas where the sensors have determined to be flat or suitable for that vehicle. As a result, the truck is not allowed to drive through unsuitable areas such as bumpy areas, sharp areas, etc. In addition, the planning algorithm in the system considers weight bearing measurements made by the sensing mechanism or a-priori knowledge stored in the database to plan the trajectories for the lifting/depositing of the containers.

The sensors that are used for detecting the pose of the container to be lifted or deposited and the sensors for measuring the support surface of the ground surrounding the container to be lifted or the area where the container is deposited include LADAR, Stereo cameras, and other ranging mechanisms. These are not the only types of sensors that can be used and include other types of sensors. LADAR is Laser Detection and Ranging and it uses light to determine the distance to an object. It can also image the target at the same time as determining the distance allowing a 3D view of the object. A stereo camera is a type of camera with two or more lenses with a separate image sensor or film frame for each lens. It simulates human binocular vision and gives the ability to capture 3D images. Ranging mechanism involves the use of acoustic signals for long-range communications.

During the final approach, direct measurements of the pose from the truck and the container are used and some examples of direct measurements include the use of ranging radios or fiducials. Ranging radios are used to make range measurements and fiducials are objects that are placed in the field of view of an imaging system which appears in the image produced, for use as a point of reference, or a measure. In addition, the autonomous vehicles automatically extend its legs to further stabilize the loading/unloading maneuver based on the trajectory selected using the planning algorithm.

In addition, the planning algorithm also takes into consideration the size of the extended legs in addition to the size of the autonomous vehicle when planning a route or a trajectory for lifting or depositing a container. Also, if the planning algorithm determines that there is no possible route for the autonomous vehicle to lift or deposit the container, it then communicates these results and findings to the autonomous vehicle driver or to the yard operator.

The container can be loaded from multiple approaching locations in many directions and the planning algorithm takes this into account and provides several choices to the autonomous vehicle operator so that he or she can select the preferred approach pose among the different options available. The yard controller specifies a list of starting poses and ending poses for the planning algorithm to sequentially process and execute. The yard controller can also specify the final poses and allows the planning algorithm to optimize the order at which the containers need to be moved.

The autonomous vehicle is not always aware of the starting poses of the containers but needs to drive a trajectory through the yard to automatically find the specified container. The final pose of the container is not specified in coordinates but is sensed by the autonomous vehicle either by using the localization beacons or by using fiducials. The use of localization beacons involves the precision localization and tracking method that makes use of beacons, which are lights or other visible objects serving as a signal or warning. Multiple autonomous vehicles are performing loading and unloading operations and the location and trajectories of each vehicle are used by the planning algorithms to deconflict trajectories or road usage.

A set of “mud proof” fiducials have been developed for the accurate alignment between the PLS and the trailer. An algorithm has also been developed to automatically position the PLS to align with the trailer in autonomous vehicles for the loading maneuver.

The level of alignment necessary for this behavior is similar in accuracy given the larger size of the platforms.

Unloading is a simpler maneuver and the system needs to automatically find a flat spot that is suitable for the unloading maneuver. There is automatic determination of the pose of the container on the ground and determination if the area needed for the loading has enough space for maneuver.

In addition, there is automatic planning and execution of the plan to position for the loading system and execution of the loading maneuver. In the case of the unloading maneuver, this comprises having the operator provide the desired pose of the container when left in the ground.

The embodiments of the invention in which an exclusive property or privilege is claimed are defined as follows:

1. A system for arranging a number of autonomous vehicles at a staging area composed of:
two or more autonomous vehicles;
a localization mechanism that provides the relative or absolute position of the autonomous vehicle to be arranged;
a pattern for aligning the autonomous vehicles at the staging area and;
a planning algorithm that can take as input the current state of the autonomous vehicles and create obstacle free trajectories that optimize the motion from this current state to a formation that matches the desired pattern.

2. The system of claim 1 wherein the pattern includes one or more of the following: the pattern of the desired assembly, order of vehicles, desired separation, starting location, ending location, or state of each autonomous vehicle.

3. The system of claim 1 wherein the pattern of the desired assembly includes line shape, v shape, staggered shaped, and other shapes.

4. The system of claim 1 wherein the state of each autonomous vehicle includes engine on, engine off, electronics on, electronics off, or service brake on or off.

5. The system of claim 1 wherein the optimization is based on one or more of the following: minimum time, minimum energy consumption, minimizing use of certain roadways or areas, minimizing time at the final position, minimize wear/tear of vehicles, minimize risk of collision or flipping.

6. The system of claim 1 wherein sensors used by the planning algorithms to only allow trajectories that are obstacle free and take the autonomous vehicles in areas that are safe that can measure obstacles, pedestrians and the support surface are located on each autonomous vehicle.

7. The system on claim 2 wherein the sensors are not only on the autonomous vehicles but also on the yard.

8. The system on claim 2 wherein the planning algorithm not only uses the sensors on one autonomous vehicle to determine the trajectories, but it uses a global map that includes obstacles and support surfaces fused from all systems in the convoy.

9. The system on claim 2 wherein the motion of each autonomous vehicle is performed one at a time.

10. The system on claim 2 wherein two or more autonomous vehicles go to their assembly area at a time.

11. The system on claim 2 wherein the planning algorithm automatically creates intermediate assembly patterns (autonomous vehicles in a line or in a far away area that is not congested) before achieving the final desired state (possibly more congested) in parallel.

12. The system on claim 2 wherein the autonomous vehicles engines are turned on and off to minimize fuel consumption.

13. The system on claim 2 wherein the planner is constantly replanning to account for changes in the yard unrelated to the assembly maneuver.

14. The system on claim 2 wherein the planner takes under consideration the order at which the autonomous vehicles are ready (being fueled or loaded) before moving them to location.

15. The system in claim 2 wherein the planner is subdivided into multiple layers. One layer computes the intermediate patterns and desired position of each vehicle, and a second layer creates trajectories for each individual autonomous vehicle that satisfies/optimizes the commands provided by the upper layer

16. The system on claim 2 wherein the optimization is based on the desired “ready to go time”.

17. The system on claim 2 wherein the intermediate staging pattern is designed to serve an intermediate need of the convoy: loading gas, cleaning, decontamination, loading cargo, unloading cargo, etc.

18. The system on claim 2 wherein the plans created for each autonomous vehicle are described in position and time for each point of the trajectory.

19. The system on claim 14 wherein the planner can share these position/time trajectories with other planners assembling other convoys or performing other yard maneuvers

20. The system on claim 2 wherein the convoy contains both manned and unmanned autonomous vehicles.

21. The system of claim 1 wherein for the manned vehicles, the planner provides a desired pose and time, and possibly a trajectory to follow, which is handed out by an interface on the autonomous vehicle or provided to the yard controller which then relays this information to each manned autonomous vehicle.
